(19) United States
(12) Patent Application Publication
(10) Pub. No.: US 2025/0368162 A1
(43) Pub. Date: Dec. 4, 2025

(54) VEHICLE, AND CLEANING METHOD AND SYSTEM FOR VEHICLE SENSOR THEREOF

(71) Applicant: AutoX, Inc., Grand Cayman (KY)

(72) Inventors: Jianxiong Xiao, Shenzhen (CN); Yizhou Shan, Shenzhen (CN)

(73) Assignee: AutoX, Inc., Grand Cayman (KY)

(21) Appl. No.: 19/221,476

(22) Filed: May 28, 2025

(30) Foreign Application Priority Data
May 28, 2024 (CN) 2024106749718

(51) Int. Cl. B60S 1/56; B60S 1/08; B60S 1/48; B60S 1/54

(52) U.S. Cl. CPC B60S 1/56; B60S 1/0818; B60S 1/485; B60S 1/54

(57) ABSTRACT

The disclosure provides a cleaning way for a vehicle sensor, the vehicle sensor has a viewport. The cleaning way includes steps of: controlling the vehicle sensor to scan the viewport to obtain viewport data of the vehicle sensor when the vehicle enters a cold start phase; determining whether dirt exists on the viewport based on the viewport data and predetermined dirt features; and controlling a cleaning device to clean the viewport when dirt on the viewport is detected. Additionally, the disclosure further provides a cleaning system for a vehicle sensor and a vehicle.

### CROSS REFERENCE TO RELATED APPLICATION

This non-provisional patent application claims priority under 35 U. S. C. § 119 from Chinese Patent Application No. 202410674971.8 filed on May 28, 2024, the entire content of which is incorporated herein by reference.

### TECHNICAL FIELD

The disclosure relates to the field of cleaning technologies, particularly to a vehicle and a cleaning method and system for a vehicle sensor thereof.

### BACKGROUND

Vehicle sensors with viewports, such as Lidar, millimeter-wave radar, and cameras, are critical components for achieving intelligent driving in vehicles. It is essential to ensure the viewports remain clean during sensor operation. Existing vehicle sensors are typically cleaned when the vehicle is parked. However, when a vehicle is powered off for an extended period or the sensor is in a power-off state with loss of internal flash memory, causing the sensor to enter a cold start phase, the vehicle cannot promptly verify the cleanliness of the sensor viewport upon restart. This may lead to inaccurate viewport data from the sensor due to dirt, adversely affecting the efficiency of intelligent driving.

### SUMMARY

In view of the above, it is necessary to propose a vehicle and a cleaning method and system for a vehicle sensor thereof.

In a first aspect, an embodiment of the disclosure provides a cleaning method for a vehicle sensor, the vehicle sensor has a viewport. The cleaning method includes steps of: controlling the vehicle sensor to scan the viewport to obtain viewport data of the vehicle sensor when the vehicle enters a cold start phase; determining whether dirt exists on the viewport based on the viewport data and predetermined dirt features; and controlling a cleaning device to clean the viewport when dirt on the viewport is detected.

In a second aspect, an embodiment of the disclosure provides a cleaning system for a vehicle sensor, the vehicle sensor has a viewport. The cleaning system comprises a main control module and a cleaning device. The main control module includes a memory for storing computer programs and a processor for executing the programs to implement the aforementioned cleaning method for a vehicle sensor.

In a third aspect, an embodiment of the disclosure provides a vehicle comprising a vehicle body. The vehicle body includes a vehicle sensor with a viewport, a cleaning device configured to clean the viewport, and a main control module. The main control module includes a memory for storing computer programs and a processor for executing the programs to implement the aforementioned cleaning method for a vehicle sensor.

The vehicle, the cleaning method and the system for the vehicle sensor ensure the viewport of the vehicle sensor remains clean during vehicle startup by controlling the sensor to scan the viewport, acquiring corresponding data, and determining dirt status using predetermined dirt features. When dirt is detected, the cleaning device is activated to clean the viewport, thereby preventing data inaccuracies caused by uncleaned dirt and enhancing the safety of intelligent driving.

### BRIEF DESCRIPTION OF THE DRAWINGS

To illustrate the technical solutions of the embodiments or the prior art more clearly, the drawings used in the embodiments or the prior art are briefly described below. Obviously, the drawings in the following description are merely some embodiments, and other drawings may be obtained by those skilled in the art without creative efforts.

FIG. 1 illustrates a first flowchart of the cleaning method for the vehicle sensor according to an embodiment.

FIG. 2 illustrates a sub-the step flowchart of the step S102 in an embodiment.

FIG. 3 illustrates a sub-the step flowchart of the step S103 in an embodiment.

FIG. 4 illustrates a sub-the step flowchart of the step S1032 in an embodiment.

FIG. 5 illustrates a second flowchart of the cleaning method for the vehicle sensor according to an embodiment.

FIG. 6 illustrates a third flowchart of the cleaning method for the vehicle sensor according to an embodiment.

FIG. 7 illustrates a fourth flowchart of the cleaning method for the vehicle sensor according to an embodiment.

FIG. 8 illustrates a flowchart of a Lidar cleaning method according to an embodiment.

FIG. 9 illustrates a flowchart of a millimeter-wave radar cleaning method according to an embodiment.

FIG. 10 illustrates a flowchart of a camera cleaning method according to an embodiment.

FIG. 11 illustrates a structural diagram of a cleaning system for the vehicle sensor according to a first embodiment.

FIG. 12 illustrates a structural diagram of a cleaning system for the vehicle sensor according to a second embodiment.

FIG. 13 illustrates a schematic diagram of a vehicle applying the cleaning method for the vehicle sensor according to an embodiment.

FIG. 14 illustrates an internal structural diagram of a main control module according to an embodiment.

The objectives, technical solutions, and advantages of the disclosure will become more apparent from the detailed description of the embodiments with reference to the drawings.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the disclosure and are not intended to limit the disclosure. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of the steps or units is not limited to only those The steps or units clearly listed but may include other The steps or units not clearly listed or inherent to those processes, methods, products, or device.

It is understood that the descriptions involving “first,” “second,” etc., in the disclosure are solely for descriptive purpos and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

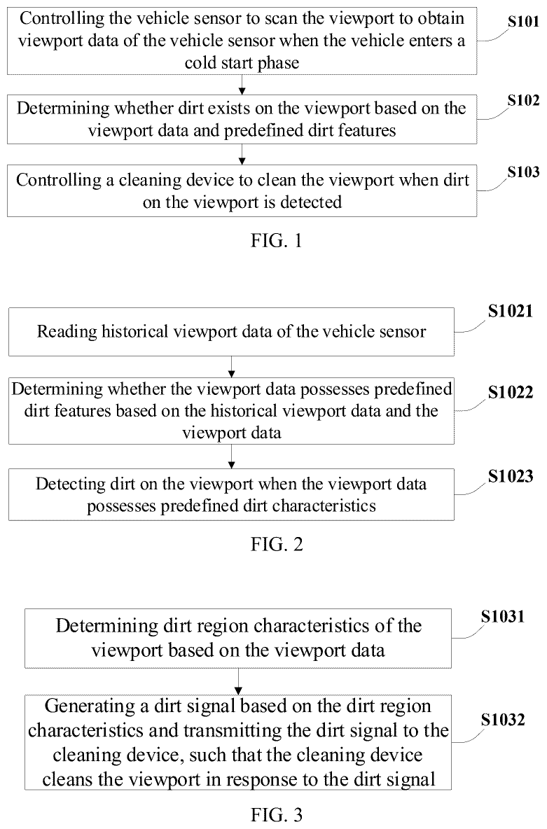

Referring to FIG. 1, which is a first flowchart of a cleaning method for a vehicle sensor provided by an embodiment of the disclosure. The disclosure provides cleaning method for a vehicle sensor, where the vehicle sensor has a viewport. The vehicle sensor in the disclosure includes, but is not limited to, components such as Lidar, millimeter-wave radar, and cameras. The vehicle sensor may also be other sensor components with a viewport, which will not be elaborated on here. The cleaning method for the vehicle sensor is applied to a vehicle equipped with the vehicle sensor to achieve cleaning of the viewport of the vehicle sensor. The cleaning method for the vehicle sensor includes steps S101-S104.

The step S101: when the vehicle enters a cold start phase, controlling the vehicle sensor to scan the viewport to obtain viewport data of the vehicle sensor.

In the step S101, the vehicle includes, but is not limited to, fuel vehicles, electric vehicles, etc., which will not be elaborated on here. The cold start phase of the vehicle is the stage when the vehicle is restarted after being shut down for a period, causing the engine temperature to drop below the normal operating temperature. When the vehicle is shut down during the cold start phase, components such as the vehicle sensor should be powered off to save the vehicle's power consumption, i.e., the vehicle sensor should be turned off. At this time, the vehicle sensor loses its flash memory information. When the vehicle is restarted, the vehicle sensor is turned on. Since the vehicle sensor loses its flash memory information, the vehicle will re-monitor the vehicle sensor to reconfigure the configuration parameters of the corresponding vehicle sensor for the vehicle, thereby determining the type of the vehicle sensor, the type of data acquired by the vehicle sensor, etc. The viewport is a component through which the vehicle sensor emits or receives data, and the viewport data is the unprocessed raw viewport data obtained by scanning the viewport surface of the vehicle sensor. When the viewport is dirty, the viewport data will exhibit distortion, data loss, etc., leading to inaccurate data. Therefore, the presence of dirt on the corresponding viewport can be detected through the viewport data. The acquisition of viewport data for different vehicle sensors will be elaborated on below.

The step S102: determining whether the viewport is dirty based on the viewport data and predetermined dirt features.

In the step S102, the predetermined dirt features are various viewport data obtained by scanning the viewport surface of the vehicle sensor when the viewport is dirty, used to reflect the corresponding data features when the viewport is dirty. The various viewport data are the historical flash memory information of the vehicle sensor stored in the vehicle. After obtaining the viewport data in the disclosure, the dirt features of the viewport are obtained through methods such as mathematical modeling or machine learning and compared with the corresponding data features of the predetermined dirt features when the viewport is dirty to confirm whether the viewport is dirty. The determination of whether the viewport is dirty based on the viewport data of different vehicle sensors will be elaborated on below.

Referring to FIG. 2, which is a flowchart of sub-the steps of the step S102 provided by an embodiment of the disclosure. Determining whether the viewport is dirty based on the viewport data and predetermined dirt features includes steps S1021-S1023.

The step S1021: reading historical viewport data of the vehicle sensor.

In the step S1021, the historical viewport data is stored in the vehicle. The historical viewport data is the viewport data of the vehicle sensor before the vehicle enters the cold start phase.

The step S1022: determining whether the viewport data has predetermined dirt features based on the historical viewport data and the viewport data.

In the step S1022, the historical viewport data contains both the corresponding data features when the viewport is dirty and when it is not dirty. The disclosure obtains the dirt features of the viewport from the data features contained in the historical viewport data through methods such as mathematical modeling or machine learning as the predetermined dirt features to determine whether the viewport data has the predetermined dirt features.

The step S1023: when the viewport data has the predetermined dirt features, determining that the viewport is dirty.

The step S103: when it is determined that the viewport is dirty, controlling the cleaning device to clean the viewport.

In the step S103, after determining that the viewport is dirty, first identify the type of dirt on the viewport of the vehicle sensor and then select a corresponding cleaning way to clean the entire viewport of the vehicle sensor, thereby further saving the consumption of the cleaning device and reducing the cleaning cost while achieving the cleaning of the viewport of the vehicle sensor.

Referring to FIG. 3, which is a flowchart of sub-the steps of the step S103 provided by an embodiment of the disclosure. Controlling the cleaning device to clean the viewport includes steps S1031-S1032.

The step S1031: determining dirt region features of the viewport based on the viewport data.

In the step S1031, the viewport data includes the viewport surface position of the vehicle sensor and the corresponding data at that position. The dirt region features are obtained from the viewport surface position and its corresponding data in the viewport data. The dirt region features include the dirt type and the dirt region. The dirt type includes, but is not limited to, oil stains, animal residues, dust, muddy water traces, feathers, flying debris, etc., which will not be elaborated on here. The dirt region is used to determine the distribution location of the dirt for subsequent effective analysis of the dirt source, thereby improving the effectiveness of subsequent preventive measures against the dirt source. For example, when it is determined from the dirt region features that the dirt type is flying debris and the dirt region is the edge of the viewport, a gas supply device that can operate according to a preset cycle can be added towards the edge of the viewport of the vehicle sensor to generate a quantitative airflow, thereby reducing the probability of the viewport of the vehicle sensor becoming dirty due to flying debris during vehicle operation.

The step S1032: generating a dirt signal based on the dirt region features and transmitting the dirt signal to the cleaning device to enable the cleaning device to clean the viewport in response to the dirt signal.

In the step S1032, after determining the dirt region features of the viewport, generate corresponding dirt signal based on the dirt type and the dirt region and transmit the corresponding dirt signal to the cleaning device so that the cleaning device can clean the corresponding viewport according to the dirt signal. The dirt signal is used to confirm the presence of dirt on the viewport, as well as to obtain relevant information about the dirt, such as its distribution and type, so that the cleaning device can clean the corresponding viewport when receiving the dirt signal. The generation of dirt signals based on the viewport data of different vehicle sensors will be elaborated on below. After the cleaning device receives the dirt signal, it can identify the type of dirt on the viewport of the vehicle sensor and then select the corresponding cleaning way to clean the entire viewport of the vehicle sensor. The vehicle sensors in the disclosure include Lidar, millimeter-wave radar, and cameras. The dirt signals include a first dirt signal, a second dirt signal, and a third dirt signal, which correspond to the viewport data of Lidar, millimeter-wave radar, and cameras, respectively. The control of the cleaning device to clean the viewports of different sensors will be elaborated on below.

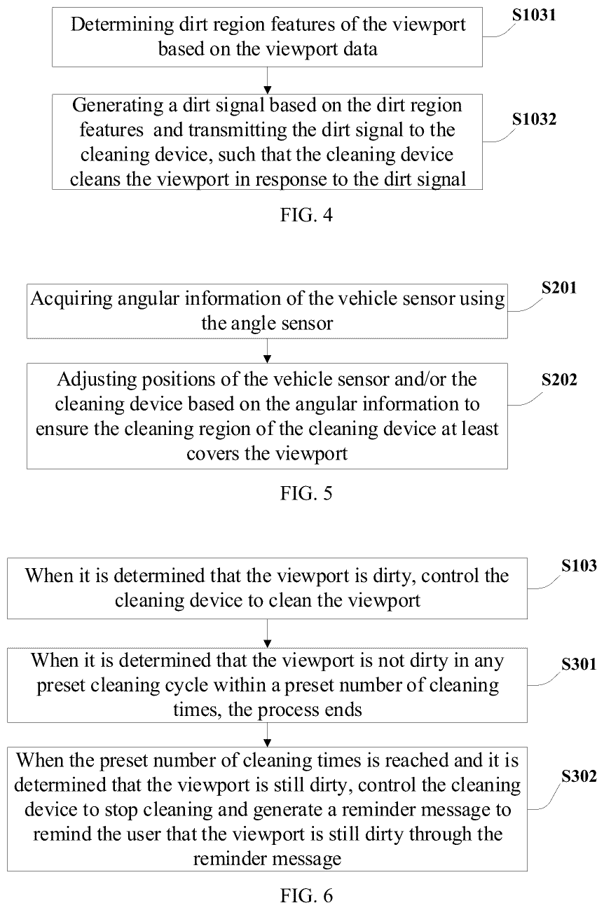

Referring to FIG. 4, which is a flowchart of sub-the steps of the step S1032 provided by an embodiment of the disclosure. The cleaning device cleans the viewport in response to the dirt signal, including the steps S10321-S10322.

The step S10321: determining the cleaning way corresponding to the dirt type based on the dirt type.

In the step S10321, the cleaning way is one or more of a detergent cleaning way, a water washing method, an air washing method, a water-air mixing method, and a wiping method. In this embodiment, the detergent cleaning way is suitable for oil stain dirt, the water washing method is suitable for dust dirt and muddy water trace dirt, the air washing method is suitable for feather dirt and flying debris dirt, the water-air mixing method is suitable for animal residue dirt, and the wiping method is suitable for stubborn dirt on the viewport. When there are multiple different types of dirt on the viewport of the vehicle sensor, multiple composite cleaning way can be determined.

The step S10322: controlling the cleaning device to clean the viewport using the corresponding cleaning way.

In some embodiments, to ensure that the viewport of the vehicle sensor can achieve a clean effect after being cleaned by the cleaning device, different cleaning gears can be added based on directly cleaning the entire viewport of the vehicle sensor with the cleaning device to autonomously adjust the cleaning frequency and cleaning intensity of the cleaning device according to the dirt situation, thereby flexibly adjusting the cleaning process of the cleaning device. To ensure that the viewport of the vehicle sensor does not exhibit phenomena such as refraction and scattering due to substances such as detergent or water remaining on the viewport after cleaning, thereby affecting the accuracy of the viewport data of the vehicle sensor, methods such as adding a wiping component or adjusting the installation angle of the cleaning device can also be used to remove substances such as detergent or water remaining on the viewport to avoid phenomena such as refraction and scattering on the cleaned viewport, thereby improving the accuracy of the viewport data of the vehicle sensor. Based on cleaning the entire viewport of the vehicle sensor with the cleaning device, the dirt region can also be first determined according to the dirt region features to determine the specific location of the dirt on the viewport of the vehicle sensor. When the area of the dirt region is smaller than the area of a preset region, the cleaning device is controlled to perform local cleaning according to the specific location to further save the consumption of the cleaning device and reduce the cleaning cost.

In some other embodiments, when it is determined based on the current viewport data that the dirt type does not belong to the dirt types in the aforementioned examples, a combination of one or more of the aforementioned cleaning way can also be used as the default cleaning way of the cleaning device, and the default cleaning way can be used to clean the viewport when it is confirmed that the dirt type determined based on the current viewport data does not belong to the dirt types in the aforementioned examples. For example, the default cleaning way can be a single cleaning way such as a detergent cleaning way or a water washing method, or a combination of a detergent cleaning way and a water washing method.

In the above embodiments, after the vehicle enters the cold start phase, the presence of dirt on the viewport of the vehicle sensor is determined by scanning the viewport to obtain viewport data, and a corresponding dirt signal is generated to control the cleaning device to clean when dirt is present. The disclosure can also achieve the coverage of the cleaning region of the cleaning device over the viewport of the vehicle sensor by adding an angle sensor to the vehicle sensor to adjust the position of the vehicle sensor and/or the cleaning device when the vehicle sensor is offset due to external forces. The angle sensor can be installed on a component that can drive the vehicle sensor to rotate for angle detection, such as a rotating motor. Below, how to achieve the coverage of the cleaning region of the cleaning device over the viewport of the vehicle sensor will be specifically elaborated.

Referring to FIG. 5, which is a second flowchart of a cleaning method for a vehicle sensor provided by an embodiment of the disclosure. The cleaning method for the vehicle sensor further includes steps S201-S202.

The step S201: reading the angle information of the vehicle sensor using an angle sensor.

In the step S201, the angle information is the angle between the current position of the vehicle sensor and a preset position. Specifically, the angle sensor obtains the corresponding preset position by acquiring the working range of the rotating motor provided for the vehicle sensor and determines the corresponding angle information by acquiring the current position and the initial position of the vehicle sensor to determine that the working range of the vehicle sensor may change due to external forces, thereby causing its rotation angle to deviate.

The step S202: adjusting the position of the vehicle sensor and/or the cleaning device according to the angle information so that the cleaning region of the cleaning device at least covers the viewport.

In the step S202, either the current position of the vehicle sensor or the cleaning region of the cleaning device can be adjusted according to the angle information, or both the current position of the vehicle sensor and the cleaning region of the cleaning device can be adjusted simultaneously according to the angle information.

It can be understood that the cleaning region of the cleaning device covers the viewport of one or more of Lidar, millimeter-wave radar, and cameras, i.e., the cleaning region of the cleaning device can either singly cover the viewport of one vehicle sensor or simultaneously cover the viewports of multiple vehicle sensors to ensure that when the cleaning device receives a single dirt signal, it only cleans the viewport of the vehicle sensor corresponding to the single dirt signal, and when it receives multiple identical or different dirt signals, it can synchronously clean the viewports of all vehicle sensors corresponding to the dirt signals or asynchronously clean the viewports of different vehicle sensors corresponding to the dirt signals according to signal features that can distinguish different dirt signals, such as the reception time of the dirt signals or the types of the dirt signals.

In the above embodiments, the adjustment of the position of the vehicle sensor and/or the cleaning device when the vehicle sensor is offset due to external forces is described to achieve the coverage of the cleaning region of the cleaning device over the viewport of the vehicle sensor. After controlling the cleaning device to clean the viewport of the vehicle sensor in the disclosure, it is necessary to determine whether the viewport of the vehicle sensor is indeed clean. Below, the method The steps of the cleaning method for the vehicle sensor will be further introduced to elaborate on how to determine whether the viewport of the vehicle sensor is indeed clean.

Referring to FIG. 6, which is a third flowchart of the cleaning method for a vehicle sensor provided by an embodiment of the disclosure. After controlling the cleaning device to clean the viewport, the cleaning method for the vehicle sensor further includes steps S301-S302.

The step S301: when it is determined that the viewport is not dirty in any predetermined cleaning cycle within a preset number of cleaning times, the process ends.

In the step S301, to avoid the cleaning device entering an infinite loop cleaning state due to the inability to remove stubborn stains, a certain number of cleaning times need to be set, and the cleaning of the cleaning device should be stopped and the user notified to promptly check the vehicle sensor when the viewport is still dirty after reaching the certain number of cleaning times. Specifically, when it is determined that the viewport is dirty in the current predetermined cleaning cycle, determine whether the preset number of cleaning times has been reached. When the preset number of cleaning times has not been reached, re-determine whether the viewport is dirty at the beginning of the next predetermined cleaning cycle until the preset number of cleaning times is reached and the viewport is still dirty, at which point it is determined that the viewport is dirty.

The step S302: when the preset number of cleaning times is reached and it is determined that the viewport is still dirty, control the cleaning device to stop cleaning and generate a reminder message to remind the user that the viewport is still dirty through the reminder message.

In the above embodiments, it is described how to generate a corresponding dirt signal to passively clean the viewport of the vehicle sensor when the vehicle sensor enters the cold start phase. The disclosure can also maintain the cleanliness of the viewport of the vehicle sensor when the vehicle is in the cold start phase and still maintain the cleanliness of the vehicle sensor when the vehicle is not in the cold start phase. Below, how to maintain the cleanliness of the vehicle sensor when the vehicle is not in the cold start phase will be specifically elaborated.

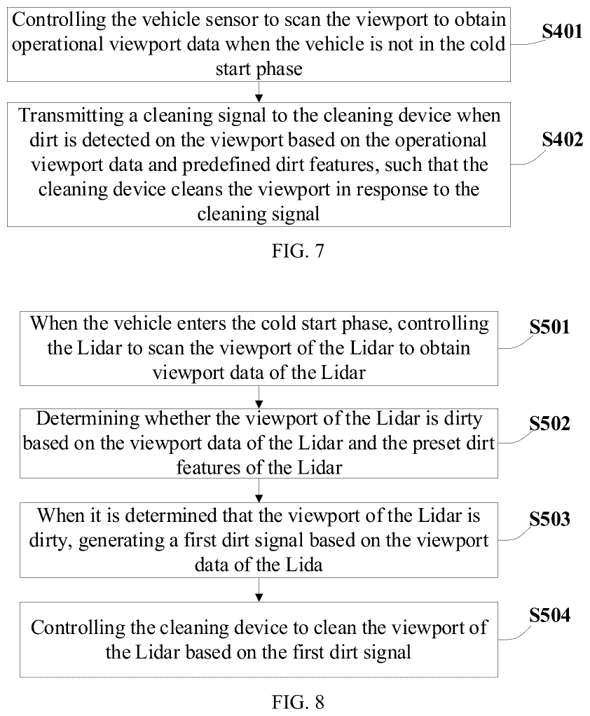

Referring to FIG. 7, which is a fourth flowchart of a cleaning method for a vehicle sensor provided by an embodiment of the disclosure. The cleaning method for the vehicle sensor further includes steps S401-S402.

The step S401: when the vehicle is not in the cold start phase, control the vehicle sensor to scan the viewport to obtain working viewport data.

In the step S401, when the vehicle is not in the cold start phase, such as entering the driving phase, the vehicle sensor is in a working state. At this time, the presence of dirt on the viewport of the vehicle sensor can be determined by obtaining the viewport data of the vehicle sensor in real-time.

The step S402: when it is determined that the viewport is dirty based on the working viewport data and predetermined dirt features, the vehicle sensor sends a cleaning signal to the cleaning device to enable the cleaning device to clean the viewport in response to the cleaning signal.

In the step S402, since the working viewport data obtained by scanning the vehicle sensor when the vehicle is not in the cold start phase can be used to determine the presence of dirt on the corresponding viewport through the predetermined dirt features, to ensure that the viewport of the vehicle sensor does not affect the acquisition of viewport data by the vehicle sensor, the cleaning device responds to the cleaning signal when receiving the cleaning signal sent by the vehicle sensor and controls the cleaning device to directly clean the entire viewport of the vehicle sensor. Preferably, when the vehicle is not in the cold start phase and the cleaning device is cleaning the viewport, the acquisition of the viewport data of the vehicle sensor is stopped, and the acquisition of the viewport data of the vehicle sensor is resumed when it is determined that the viewport is not dirty in any predetermined cleaning cycle within the preset number of cleaning times to avoid affecting the safety of the vehicle's intelligent driving when the vehicle is not in the cold start phase due to the acquisition of viewport data corresponding to a dirty viewport.

In the above embodiments, it is described how the vehicle sensor directly sends a cleaning signal to the cleaning device to maintain the cleanliness of the vehicle sensor when the vehicle is not in the cold start phase. Below, how the cleaning method for the vehicle sensor acquires the viewport data of different vehicle sensors, determines whether the viewport is dirty based on the viewport data of different vehicle sensors, generates dirt signals based on the viewport data of different vehicle sensors, and controls the cleaning device to clean the viewports of different sensors will be specifically elaborated.

Referring to FIG. 8, which is a flowchart of a cleaning method for Lidar provided by an embodiment of the disclosure. The cleaning method for Lidar includes steps S501-S504.

The step S501: When the vehicle enters the cold start phase, control the Lidar to scan the viewport of the Lidar to obtain viewport data of the Lidar.

In the step S501, the viewport of the Lidar is a component through which the Lidar emits or receives laser beams. The viewport data of the Lidar includes optical signal data, where the optical signal data is the optical signal corresponding to each position on the viewport surface. The optical signal data can be the raw signal data when the optical signal is reflected back to the receiving device of the Lidar through the viewport or the signal data after data processing by the receiving device after receiving the signal data. When the viewport of the Lidar is dirty, the viewport data of the Lidar will exhibit distortion, data loss, etc., leading to inaccurate data. Therefore, the presence of dirt on the viewport of the Lidar can be detected through the viewport data of the Lidar. The viewport data of the Lidar is the unprocessed raw optical signal data.

The step S502: Determine whether the viewport of the Lidar is dirty based on the viewport data of the Lidar and the predetermined dirt features of the Lidar.

In the step S502, after obtaining the viewport data of the Lidar, determine whether the viewport of the Lidar is dirty based on the viewport data of the Lidar and the predetermined dirt features of the Lidar. The predetermined dirt features of the Lidar are the features that appear when the viewport of the Lidar is dirty, such as abnormal occlusion of environmental point clouds or abnormal signal intensity. After obtaining the viewport data, obtain the dirt features of the viewport of the Lidar through methods such as mathematical modeling or machine learning and compare them with the predetermined dirt features of the Lidar to confirm whether the viewport of the Lidar is dirty.

In this embodiment, the viewport data of the Lidar can also be point cloud data. In the disclosure, based on determining whether the viewport of the Lidar is dirty using the raw optical signal data, the dirt features of the viewport of the Lidar can be obtained through methods such as mathematical modeling or machine learning combined with point cloud data to determine whether the viewport of the Lidar is dirty, or the presence of dirt on the viewport of the Lidar can be comprehensively determined by combining the raw optical signal data with the point cloud data.

The step S503: When it is determined that the viewport of the Lidar is dirty, generate a first dirt signal based on the viewport data of the Lidar.

In the step S503, the first dirt signal is used to confirm the presence of dirt on the viewport of the Lidar, as well as to obtain relevant information about the dirt, such as its distribution and type, so that the cleaning device can clean the viewport of the Lidar when receiving the first dirt signal. Specifically, determine the dirt region features of the viewport of the Lidar based on the viewport data of the Lidar. The viewport data includes the viewport surface position of the Lidar and the corresponding data at that position. After obtaining the dirt region features of the viewport of the Lidar, generate the first dirt signal based on the dirt type and the dirt region and send it to the cleaning device so that the cleaning device can clean the viewport of the Lidar according to the first dirt signal.

the step S504: controlling the cleaning device to clean the viewport of the Lidar based on the first dirt signal.

In the step S504, after the cleaning device receives the first dirt signal, it can identify the type of dirt on the viewport of the Lidar and then select the corresponding cleaning way to clean the entire viewport of the Lidar, thereby further saving the consumption of the cleaning device and reducing the cleaning cost while achieving the cleaning of the viewport of the Lidar. Specifically, after receiving the first dirt signal, the cleaning device determines the cleaning way corresponding to the dirt type based on the dirt type. After determining the corresponding cleaning way, the cleaning device cleans the viewport of the Lidar using the corresponding cleaning way.

In some embodiments, to ensure that the viewport of the Lidar achieves a clean effect after being cleaned by the cleaning device, different cleaning levels are added based on directly cleaning the entire viewport of the Lidar with the cleaning device to autonomously adjust the cleaning frequency and cleaning intensity of the cleaning device according to the dirt situation, thereby flexibly adjusting the cleaning process of the cleaning device. To ensure that the viewport of the Lidar does not exhibit phenomena such as refraction and scattering after cleaning due to substances such as detergent or water remaining on the viewport, thereby affecting the accuracy of the viewport data of the Lidar, methods such as adding a wiping component or adjusting the installation angle of the cleaning device can also be used to remove substances such as detergent or water remaining on the viewport to avoid phenomena such as refraction and scattering on the cleaned viewport, thereby improving the accuracy of the viewport data of the Lidar.

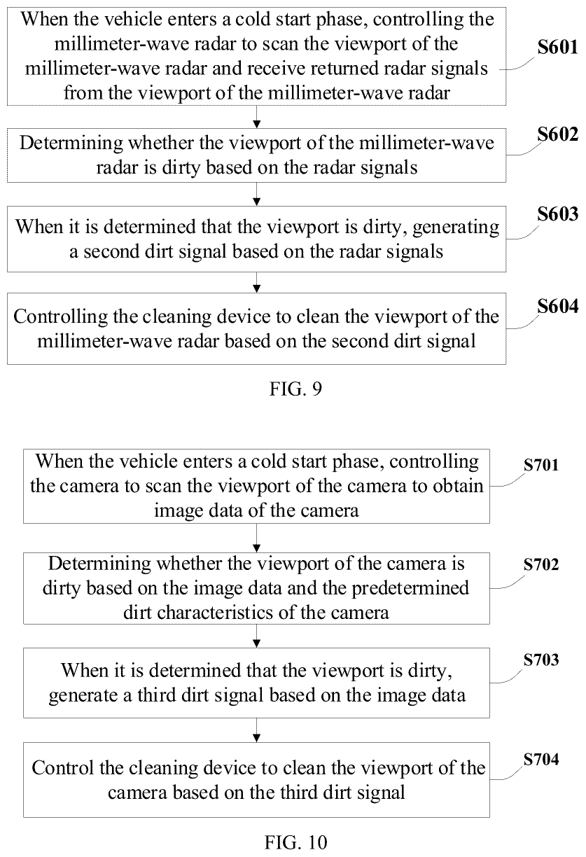

Referring to FIG. 9, which is a flowchart of a cleaning method for a millimeter-wave radar provided by an embodiment of the disclosure. The cleaning method for the millimeter-wave radar includes steps S601-S604.

the step S601: when the vehicle enters a cold start phase, controlling the millimeter-wave radar to scan the viewport of the millimeter-wave radar and receive returned radar signals from the viewport of the millimeter-wave radar.

In the step S601, the viewport of the millimeter-wave radar is a component through which the millimeter-wave radar emits or receives radar signals. When the viewport is dirty, the radar signals acquired by the millimeter-wave radar through the viewport will change. The radar signals can be either raw radar signals that have not undergone data processing or radar signals that have undergone data processing after being received from the viewport of the millimeter-wave radar. The millimeter-wave radar can determine whether the radar signals conform to the feature of a dirty viewport based on the waveform characteristics of the received radar signals. Therefore, the presence of dirt on the viewport of the millimeter-wave radar can be detected through the radar signals. The radar signals include signal-to-noise ratio (SNR) values corresponding to each position on the viewport.

the step S602: determining whether the viewport of the millimeter-wave radar is dirty based on the radar signals.

In the step S602, when the SNR values of the radar signals are abnormal compared to preset SNR values, the waveform characteristics of the radar signals conform to the feature of a dirty viewport, thereby determining that the viewport of the millimeter-wave radar is dirty.

the step S603: when it is determined that the viewport is dirty, generating a second dirt signal based on the radar signals.

In the step S603, the second dirt signal is used to confirm the presence of dirt on the viewport of the millimeter-wave radar and obtain the dirt type of the dirt so that the cleaning device can clean the viewport of the millimeter-wave radar when receiving the second dirt signal. Specifically, determine the dirt region features of the viewport of the millimeter-wave radar based on the viewport data of the millimeter-wave radar to obtain the corresponding dirt type. After obtaining the dirt type of the viewport of the millimeter-wave radar, generate the second dirt signal based on the dirt type and send it to the cleaning device so that the cleaning device can clean the viewport of the millimeter-wave radar according to the second dirt signal.

the step S604: controlling the cleaning device to clean the viewport of the millimeter-wave radar based on the second dirt signal.

In the step S604, after the cleaning device receives the second dirt signal, it can identify the type of dirt on the viewport of the millimeter-wave radar and then select the corresponding cleaning way to clean the entire viewport of the millimeter-wave radar, thereby further saving the consumption of the cleaning device and reducing the cleaning cost while achieving the cleaning of the viewport of the millimeter-wave radar. Specifically, after receiving the second dirt signal, the cleaning device determines the cleaning way corresponding to the dirt type based on the dirt type. After determining the corresponding cleaning way, the cleaning device cleans the viewport of the millimeter-wave radar using the corresponding cleaning way.

In some embodiments, to ensure that the viewport of the millimeter-wave radar achieves a clean effect after being cleaned by the cleaning device, different cleaning levels are added based on directly cleaning the entire viewport of the millimeter-wave radar with the cleaning device to autonomously adjust the cleaning frequency and cleaning intensity of the cleaning device according to the dirt situation, thereby flexibly adjusting the cleaning process of the cleaning device. To ensure that the viewport of the millimeter-wave radar does not exhibit phenomena such as refraction and scattering after cleaning due to substances such as detergent or water remaining on the viewport, thereby affecting the accuracy of the viewport data of the millimeter-wave radar, methods such as adding a wiping component or adjusting the installation angle of the cleaning device can also be used to remove substances such as detergent or water remaining on the viewport to avoid phenomena such as refraction and scattering on the cleaned viewport, thereby improving the accuracy of the viewport data of the millimeter-wave radar.

Referring to FIG. 10, which is a flowchart of a cleaning method for a camera provided by an embodiment of the disclosure. The cleaning method for the camera includes steps S701-S704.

the step S701: when the vehicle enters a cold start phase, controlling the camera to scan the viewport of the camera to obtain image data of the camera.

In the step S701, the image data can be either raw image data that has not undergone data processing or image data obtained after data processing after scanning the viewport of the camera. The image data includes pixels of the image on the viewport surface of the camera and the corresponding image data of the pixels. When the viewport is dirty, the image data will exhibit dirty image data. Therefore, the presence of dirt on the viewport of the camera can be detected through the image data.

the step S702: determining whether the viewport of the camera is dirty based on the image data and the predetermined dirt features of the camera.

In the step S702, after obtaining the image data of the camera, determine whether the viewport of the camera is dirty based on the image data of the camera and the predetermined dirt features of the camera. The predetermined dirt features of the camera are various image data obtained by scanning the viewport surface of the camera when the viewport of the camera is dirty, used to reflect the corresponding image data features when the viewport of the camera is dirty. After obtaining the image data of the camera, obtain the dirt features of the viewport of the camera through methods such as mathematical modeling or machine learning and compare them with the predetermined dirt features of the camera to confirm whether the viewport of the camera is dirty.

the step S703: when it is determined that the viewport is dirty, generating a third dirt signal based on the image data.

In the step S703, the third dirt signal is used to confirm the presence of dirt on the viewport of the camera and obtain the dirt type of the dirt so that the cleaning device can clean the viewport of the camera when receiving the third dirt signal. Specifically, determine the dirt region features of the viewport of the camera based on the image data of the camera to obtain the corresponding dirt type. After obtaining the dirt type of the viewport of the camera, generate the third dirt signal based on the dirt type and send it to the cleaning device so that the cleaning device can clean the viewport of the camera according to the third dirt signal.

the step S704: controlling the cleaning device to clean the viewport of the camera based on the third dirt signal.

In the step S704, after the cleaning device receives the third dirt signal, it can identify the type of dirt on the viewport of the camera and then select the corresponding cleaning way to clean the entire viewport of the camera, thereby further saving the consumption of the cleaning device and reducing the cleaning cost while achieving the cleaning of the viewport of the camera. Specifically, after receiving the third dirt signal, the cleaning device determines the cleaning way corresponding to the dirt type based on the dirt type. After determining the corresponding cleaning way, the cleaning device cleans the viewport of the camera using the corresponding cleaning way.

In some embodiments, to ensure that the viewport of the camera achieves a clean effect after being cleaned by the cleaning device, different cleaning levels are added based on directly cleaning the entire viewport of the camera with the cleaning device to autonomously adjust the cleaning frequency and cleaning intensity of the cleaning device according to the dirt situation, thereby flexibly adjusting the cleaning process of the cleaning device. To ensure that the viewport of the camera does not exhibit phenomena such as refraction and scattering after cleaning due to substances such as detergent or water remaining on the viewport, thereby affecting the accuracy of the image data of the camera, methods such as adding a wiping component or adjusting the installation angle of the cleaning device can also be used to remove substances such as detergent or water remaining on the viewport to avoid phenomena such as refraction and scattering on the cleaned viewport, thereby improving the accuracy of the image data of the camera.

It can be understood that the aforementioned vehicle sensors, such as Lidar, millimeter-wave radar, and cameras, are merely examples and do not limit the types of vehicle sensors. The vehicle sensors are not limited to those with viewports, such as Lidar, millimeter-wave radar, and cameras, but can also be other vehicle sensors with viewports, which will not be elaborated on here.

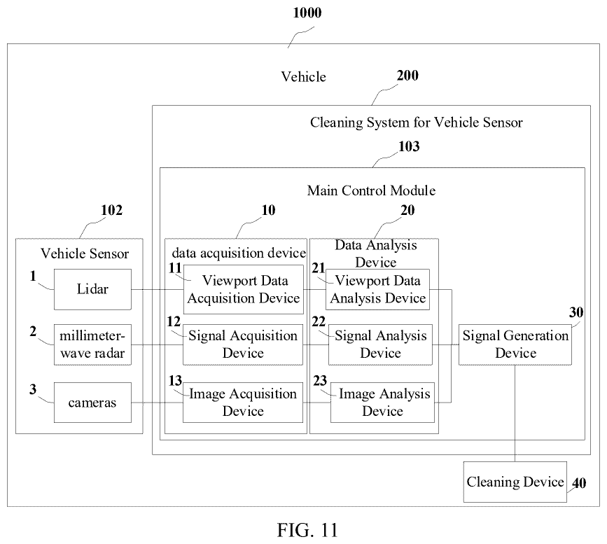

Referring to FIG. 11, which is a structural diagram of a cleaning system for a vehicle sensor provided by a first embodiment of the disclosure.

As shown in FIG. 11, the disclosure also provides, through a first embodiment, a cleaning system 200 for a vehicle sensor. The cleaning system 200 for a vehicle sensor is applied to a vehicle 1000 equipped with a vehicle sensor 102. The vehicle sensor 102 has a viewport. The vehicle sensor 102 in the disclosure includes, but is not limited to, components such as Lidar 1, millimeter-wave radar 2, and cameras 3. The vehicle sensor 102 can also be other sensor components with viewports, which will not be elaborated on here. Below, the specific features of each component in the cleaning system 200 for a vehicle sensor will be elaborated through different embodiments.

In the first embodiment, the cleaning system 200 for a vehicle sensor includes a main control module 103 and a cleaning device 40. The main control module 103 includes a data acquisition device 10 and a data analysis device 20.

When the vehicle sensor 102 enters a cold start phase, the data acquisition device 10 is used to control the vehicle sensor 102 to scan the viewport to obtain viewport data of the vehicle sensor 102. The vehicle 1000 includes, but is not limited to, fuel vehicles, electric vehicles, etc., which will not be elaborated on here. The cold start phase of the vehicle 1000 is the stage when the vehicle 1000 is restarted after being shut down for a period, causing the engine temperature to drop below the normal operating temperature. When the vehicle 1000 is shut down during the cold start phase, components such as the vehicle sensor 102 should be powered off to save the vehicle's power consumption, i.e., the vehicle sensor 102 should be turned off. At this time, the vehicle sensor 102 loses its flash memory information. When the vehicle 1000 is restarted, the vehicle sensor 102 is turned on. Since the vehicle sensor 102 loses its flash memory information, the vehicle 1000 will re-monitor the vehicle sensor 102 to reconfigure the configuration parameters of the corresponding vehicle sensor 102 for the vehicle 1000, thereby determining the type of the vehicle sensor 102, the type of data acquired by the vehicle sensor 102, etc. The viewport is a component through which the vehicle sensor 102 emits or receives data, and the viewport data is the unprocessed raw viewport data obtained by scanning the viewport surface of the vehicle sensor 102. When the viewport is dirty, the viewport data will exhibit distortion, data loss, etc., leading to inaccurate data. Therefore, the data acquisition device 10 can detect the presence of dirt on the corresponding viewport through the viewport data.

The data analysis device 20 is used to determine whether the viewport is dirty based on the viewport data and predetermined dirt features. The predetermined dirt features are various viewport data obtained by scanning the viewport surface of the vehicle sensor 102 when the viewport is dirty, used to reflect the corresponding data features when the viewport is dirty. The various viewport data are the historical flash memory information of the vehicle sensor 102 stored in the vehicle 1000. After the data acquisition device 10 obtains the viewport data in the disclosure, the data analysis device 20 obtains the dirt features of the viewport through methods such as mathematical modeling or machine learning and compares them with the corresponding data features of the predetermined dirt features when the viewport is dirty to confirm whether the viewport is dirty. Specifically, the data analysis device 20 reads the historical viewport data of the vehicle sensor 102 and determines whether the viewport data has the predetermined dirt features based on the historical viewport data and the viewport data. When the viewport data has the predetermined dirt features, the data analysis device 20 determines that the viewport is dirty.

When the data analysis device 20 determines that the viewport is dirty, the cleaning device 40 is used to clean the viewport. After the data analysis device 20 determines that the viewport is dirty, the cleaning device 40 first identifies the type of dirt on the viewport of the vehicle sensor and then selects the corresponding cleaning way to clean the entire viewport of the vehicle sensor, thereby further saving the consumption of the cleaning device and reducing the cleaning cost while achieving the cleaning of the viewport of the vehicle sensor.

In the first embodiment, the cleaning system 200 for a vehicle sensor further includes a signal generation device 30. When it is determined that the viewport is dirty, the signal generation device 30 is used to determine the dirt region features of the viewport based on the viewport data and generate and send a dirt signal to the cleaning device 40 based on the dirt region features so that the cleaning device 40 cleans the viewport in response to the dirt signal. The viewport data includes the viewport surface position of the vehicle sensor 102 and the corresponding data at that position. The dirt region features are obtained from the viewport surface position and its corresponding data in the viewport data. The dirt region features include the dirt type and the dirt region. The dirt type includes, but is not limited to, oil stains, animal residues, dust, muddy water traces, feathers, flying debris, etc., which will not be elaborated on here. The dirt region is used to determine the distribution location of the dirt for subsequent effective analysis of the dirt source, thereby improving the effectiveness of subsequent preventive measures against the dirt source. After determining the dirt region features of the viewport, the signal generation device 30 generates a corresponding dirt signal based on the dirt type and the dirt region and sends it to the cleaning device 40 so that the cleaning device 40 can clean the corresponding viewport according to the dirt signal. The dirt signal is used to confirm the presence of dirt on the viewport, as well as to obtain relevant information about the dirt, such as its distribution and type, so that the cleaning device 40 can clean the corresponding viewport when receiving the dirt signal. After the cleaning device 40 receives the dirt signal, it can identify the type of dirt on the viewport of the vehicle sensor 102 and then select the corresponding cleaning way to clean the entire viewport of the vehicle sensor. Specifically, the cleaning device 40 determines the cleaning way corresponding to the dirt type based on the dirt type. The cleaning way is one or more of a detergent cleaning way, a water washing method, an air washing method, a water-air mixing method, and a wiping method. In this embodiment, the detergent cleaning way is suitable for oil stain dirt, the water washing method is suitable for dust dirt and muddy water trace dirt, the air washing method is suitable for feather dirt and flying debris dirt, the water-air mixing method is suitable for animal residue dirt, and the wiping method is suitable for stubborn dirt on the viewport. When there are multiple different types of dirt on the viewport of the vehicle sensor 102, multiple composite cleaning way can be determined. After determining the cleaning way corresponding to the dirt type, the cleaning device 40 cleans the viewport using the corresponding cleaning way.

In some embodiments, to ensure that the viewport of the vehicle sensor 102 achieves a clean effect after being cleaned by the cleaning device 40, different cleaning levels are added based on directly cleaning the entire viewport of the vehicle sensor 102 with the cleaning device 40 to autonomously adjust the cleaning frequency and cleaning intensity of the cleaning device 40 according to the dirt situation, thereby flexibly adjusting the cleaning process of the cleaning device 40. To ensure that the viewport of the vehicle sensor 102 does not exhibit phenomena such as refraction and scattering after cleaning due to substances such as detergent or water remaining on the viewport, thereby affecting the accuracy of the viewport data of the vehicle sensor 102, methods such as adding a wiping component or adjusting the installation angle of the cleaning device 40 can also be used to remove substances such as detergent or water remaining on the viewport to avoid phenomena such as refraction and scattering on the cleaned viewport, thereby improving the accuracy of the viewport data of the vehicle sensor 102. Based on cleaning the entire viewport of the vehicle sensor 102 with the cleaning device 40, the dirt region can also be first determined through the signal generation device 30 based on the dirt region features and sent to the cleaning device 40 to determine the specific location of the dirt on the viewport of the vehicle sensor 102. When the area of the dirt region is smaller than the area of a preset region, the cleaning device 40 is controlled to perform local cleaning according to the specific location to further save the consumption of the cleaning device 40 and reduce the cleaning cost.

In some other embodiments, when the signal generation device 30 determines based on the current viewport data that the dirt type does not belong to the dirt types in the aforementioned examples, the cleaning system 200 for a vehicle sensor can also use a combination of one or more of the aforementioned cleaning way as the default cleaning way of the cleaning device 40 and control the cleaning device 40 to use the default cleaning way to clean the viewport when the signal generation device 30 confirms that the dirt type determined based on the current viewport data does not belong to the dirt types in the aforementioned examples. For example, the default cleaning way can be a single cleaning way such as a detergent cleaning way or a water washing method, or a combination of a detergent cleaning way and a water washing method.

In the first embodiment, the data acquisition device 10 includes a viewport data acquisition device 11, and the data analysis device 20 includes a viewport data analysis device 21.

When the vehicle 1000 enters a cold start phase, the viewport data acquisition device 11 is used to control the Lidar 1 to scan the viewport of the Lidar 1 to obtain viewport data of the Lidar 1. The viewport of the Lidar 1 is a component through which the Lidar 1 emits or receives laser beams. The viewport data of the Lidar 1 includes optical signal data, where the optical signal data is the optical signal corresponding to each position on the viewport surface. The optical signal data can be the raw signal data when the optical signal is reflected back to the receiving device of the Lidar 1 through the viewport or the signal data after data processing by the receiving device after receiving the signal data. When the viewport of the Lidar 1 is dirty, the viewport data of the Lidar 1 will exhibit distortion, data loss, etc., leading to inaccurate data.

The viewport data analysis device 21 is used to determine whether the viewport of the Lidar 1 is dirty based on the viewport data of the Lidar 1 and the predetermined dirt features of the Lidar 1. Specifically, after the viewport data acquisition device 11 obtains the viewport data of the Lidar 1, the viewport data analysis device 21 determines whether the viewport of the Lidar 1 is dirty based on the viewport data of the Lidar 1 and the predetermined dirt features of the Lidar 1. The predetermined dirt features of the Lidar 1 are the features that appear when the viewport of the Lidar 1 is dirty, such as abnormal occlusion of environmental point clouds or abnormal signal intensity. After obtaining the viewport data, the viewport data analysis device 21 obtains the dirt features of the viewport of the Lidar 1 through methods such as mathematical modeling or machine learning and compares them with the predetermined dirt features of the Lidar 1 to confirm whether the viewport of the Lidar 1 is dirty. The viewport data of the Lidar 1 in the disclosure can also be point cloud data. The viewport data analysis device 21 in the disclosure can obtain the dirt features of the viewport of the Lidar 1 through methods such as mathematical modeling or machine learning combined with point cloud data to determine whether the viewport of the Lidar 1 is dirty based on the raw optical signal data, or comprehensively determine the presence of dirt on the viewport of the Lidar 1 by combining the raw optical signal data with the point cloud data.

When it is determined that the viewport of the Lidar 1 is dirty, the signal generation device 30 is further used to generate a first dirt signal based on the viewport data of the Lidar 1. The first dirt signal is used to confirm the presence of dirt on the viewport of the Lidar 1 and obtain relevant information about the dirt, such as the distribution and type of dirt on the Lidar 1, so that the cleaning device 40 can clean the viewport of the Lidar 1 when receiving the first dirt signal. Specifically, the dirt region features of the viewport of the Lidar 1 are determined based on the viewport data of the Lidar 1. The viewport data includes the viewport surface position of the Lidar 1 and the corresponding data at that position. After obtaining the dirt region features of the viewport of the Lidar 1, the signal generation device 30 generates the first dirt signal based on the dirt type and the dirt region and sends it to the cleaning device 40 so that the cleaning device 40 can clean the viewport of the Lidar 1 according to the first dirt signal.

The cleaning device 40 is further used to clean the viewport of the Lidar 1 based on the first dirt signal. After receiving the first dirt signal, the cleaning device 40 can identify the type of dirt on the viewport of the Lidar 1 and then select the corresponding cleaning way to clean the entire viewport of the Lidar, thereby further saving the consumption of the cleaning device 40 and reducing the cleaning cost while achieving the cleaning of the viewport of the Lidar 1. Specifically, after receiving the first dirt signal, the cleaning device 40 determines the cleaning way corresponding to the dirt type based on the dirt type. After determining the corresponding cleaning way, the cleaning device 40 cleans the viewport of the Lidar 1 using the corresponding cleaning way.

In some embodiments, after obtaining the raw viewport data of the vehicle sensor 102 by scanning the viewport with the data acquisition device 10, the raw viewport data can be first processed by the main control module 103 to obtain the data features of the viewport data, and then the data analysis device 20 can directly determine whether the viewport of the vehicle sensor 102 is dirty.

For example, when the vehicle sensor 102 is one or more of a Lidar 1, a millimeter-wave radar 2, and a camera 3, after obtaining the raw viewport data (viewport data of the Lidar 1, radar signals of the millimeter-wave radar 2, and image data of the camera 3) of the Lidar 1, the millimeter-wave radar 2, and the camera 3 by scanning the viewport with the data acquisition device 10, the raw viewport data of the Lidar 1, the millimeter-wave radar 2, and the camera 3 is first processed by the main control module 103 to obtain the data features of the corresponding viewport data, and then the data analysis device 20 directly determines whether the viewport of one or more of the Lidar 1, the millimeter-wave radar 2, and the camera 3 is dirty.

In the first embodiment, the data acquisition device 10 includes a signal acquisition device 12, and the data analysis device 20 includes a signal analysis device 22.

When the vehicle 1000 enters a cold start phase, the signal acquisition device 12 is used to control the millimeter-wave radar 2 to scan the viewport of the millimeter-wave radar 2 and receive returned radar signals from the viewport of the millimeter-wave radar 2. The viewport of the millimeter-wave radar 2 is a component through which the millimeter-wave radar 2 emits or receives radar signals. When the viewport is dirty, the radar signals acquired by the millimeter-wave radar 2 through the viewport will change. The radar signals can be either raw radar signals that have not undergone data processing or radar signals that have undergone data processing after being received from the viewport of the millimeter-wave radar 2. The millimeter-wave radar 2 can determine whether the radar signals conform to the features of a dirty viewport based on the waveform characteristics of the received radar signals. Therefore, the signal acquisition device 12 can detect the presence of dirt on the viewport of the millimeter-wave radar 2 through the radar signals. The radar signals include SNR values corresponding to each position on the viewport.

The signal analysis device 22 is used to determine whether the viewport of the millimeter-wave radar 2 is dirty based on the radar signals. Specifically, when the SNR values of the radar signals are abnormal compared to preset SNR values, the signal analysis device 22 determines that the waveform characteristics of the radar signals conform to the features of a dirty viewport, thereby determining that the viewport of the millimeter-wave radar 2 is dirty.

When the signal analysis device 22 determines that the viewport is dirty, the signal generation device 30 is further used to generate a second dirt signal based on the radar signals. The second dirt signal is used to confirm the presence of dirt on the viewport of the millimeter-wave radar 2 and obtain the dirt type of the dirt so that the cleaning device 40 can clean the viewport of the millimeter-wave radar 2 when receiving the second dirt signal. Specifically, based on the viewport data of the millimeter-wave radar 2, the signal generation device 30 determines the dirt region features of the viewport of the millimeter-wave radar 2 to obtain the corresponding dirt type. After obtaining the dirt type of the viewport of the millimeter-wave radar 2, the signal generation device 30 generates the second dirt signal based on the dirt type and sends it to the cleaning device 40 so that the cleaning device 40 can clean the viewport of the millimeter-wave radar 2 according to the second dirt signal.

The cleaning device 40 is further used to clean the viewport of the millimeter-wave radar 2 based on the second dirt signal. After receiving the second dirt signal, the cleaning device 40 can identify the type of dirt on the viewport of the millimeter-wave radar 2 and then select the corresponding cleaning way to clean the entire viewport of the millimeter-wave radar 2, thereby further saving the consumption of the cleaning device 40 and reducing the cleaning cost while achieving the cleaning of the viewport of the millimeter-wave radar 2. Specifically, after receiving the second dirt signal, the cleaning device 40 determines the cleaning way corresponding to the dirt type based on the dirt type. After determining the corresponding cleaning way, the cleaning device 40 cleans the viewport of the millimeter-wave radar 2 using the corresponding cleaning way.

In the first embodiment, the data acquisition device 10 includes an image acquisition device 13, and the data analysis device 20 includes an image analysis device 23.

When the vehicle 1000 enters a cold start phase, the image acquisition device 13 is used to control the camera 3 to scan the viewport of the camera 3 to obtain image data of the camera 3. The image data can be either raw image data that has not undergone data processing or image data obtained after data processing after scanning the viewport of the camera 3. The image data includes pixels of the image on the viewport surface of the camera 3 and the corresponding image data of the pixels. When the viewport is dirty, the image data will exhibit dirty image data. Therefore, the image acquisition device 13 can detect the presence of dirt on the viewport of the camera 3 through the image data.

The image analysis device 23 is used to determine whether the viewport of the camera 3 is dirty based on the image data and the predetermined dirt features of the camera 3. Specifically, after obtaining the image data of the camera 3, the image analysis device 23 determines whether the viewport of the camera 3 is dirty based on the image data of the camera 3 and the predetermined dirt features of the camera 3. The predetermined dirt features of the camera 3 are various image data obtained by scanning the viewport surface of the camera 3 when the viewport of the camera 3 is dirty, used to reflect the corresponding image data features when the viewport of the camera 3 is dirty. After obtaining the image data of the camera 3, the image analysis device 23 obtains the dirt features of the viewport of the camera 3 through methods such as mathematical modeling or machine learning and compares them with the predetermined dirt features of the camera 3 to confirm whether the viewport of the camera 3 is dirty.

When it is determined that the viewport is dirty, the signal generation device 30 is further used to generate a third dirt signal based on the image data. The third dirt signal is used to confirm the presence of dirt on the viewport of the camera 3 and obtain the dirt type of the dirt so that the cleaning device 40 can clean the viewport of the camera 3 when receiving the third dirt signal. Specifically, based on the image data of the camera 3, the signal generation device 30 determines the dirt region features of the viewport of the camera 3 to obtain the corresponding dirt type. After obtaining the dirt type of the viewport of the camera 3, the signal generation device 30 generates the third dirt signal based on the dirt type and sends it to the cleaning device 40 so that the cleaning device 40 can clean the viewport of the camera 3 according to the third dirt signal.

The cleaning device 40 is further used to clean the viewport of the camera 3 based on the third dirt signal. After receiving the third dirt signal, the cleaning device 40 can identify the type of dirt on the viewport of the camera 3 and then select the corresponding cleaning way to clean the entire viewport of the camera 3, thereby further saving the consumption of the cleaning device 40 and reducing the cleaning cost while achieving the cleaning of the viewport of the camera 3. Specifically, after receiving the third dirt signal, the cleaning device 40 determines the cleaning way corresponding to the dirt type based on the dirt type. After determining the corresponding cleaning way, the cleaning device 40 cleans the viewport of the camera 3 using the corresponding cleaning way.

In the above embodiments, after the vehicle 1000 enters a cold start phase, the raw viewport data of the vehicle sensor 102 is obtained by scanning the viewport with the data acquisition device 10, and the raw viewport data is processed by the data analysis device 20 to obtain the data features of the viewport data and determine whether the viewport of the vehicle sensor 102 is dirty. When dirt is present, a dirt signal is generated by the signal generation device 30 to control the cleaning device 40 to clean.

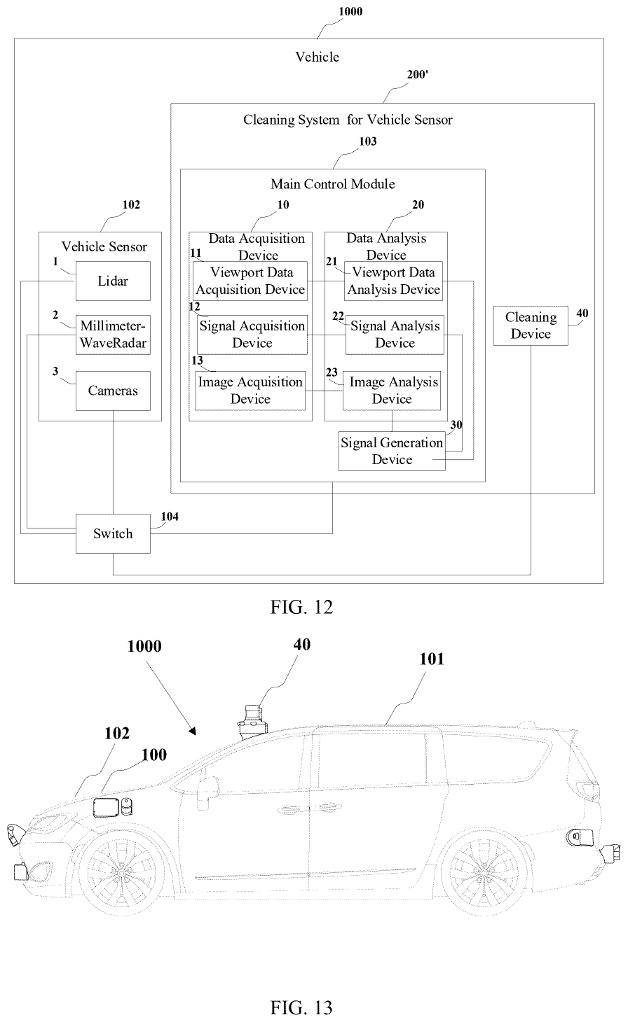

Referring to FIG. 12, which is a structural diagram of a cleaning system for a vehicle sensor provided by a second embodiment of the disclosure.

As shown in FIG. 12, the disclosure also provides, through a second embodiment, a cleaning system 200′ for a vehicle sensor. The difference between the cleaning system 200′ for a vehicle sensor provided by the second embodiment and the cleaning system 200 for a vehicle sensor provided by the first embodiment is that data transmission between the vehicle sensor 102, the main control module 103, and the cleaning device 40 is all performed through a switch 104. That is, after one or more of the Lidar 1, the millimeter-wave radar 2, and the camera 3 scan the corresponding viewport to obtain viewport data, the viewport data is sent to the switch 104. After the main control module 103 receives the corresponding viewport data through the switch 104, the signal generation device 30 generates the corresponding dirt signal and sends it to the switch 104. The cleaning device 40 receives the dirt signal sent by the signal generation device 30 through the switch 104.

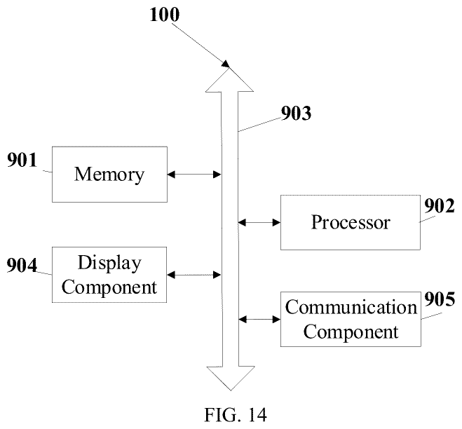

Referring to FIG. 13, which is a diagram of a vehicle 1000 to which the cleaning method for a vehicle sensor provided by an embodiment of the disclosure is applied.

As shown in FIG. 13, the disclosure also provides a vehicle 1000. The vehicle 1000 includes a vehicle body 101. The vehicle body 101 includes a vehicle sensor 102, a cleaning device 40, and a main control module 100. The vehicle sensor 102 has a viewport. The vehicle sensor 102 includes, but is not limited to, a Lidar 1, a millimeter-wave radar 2, a camera 3, etc. The Lidar 1, the millimeter-wave radar 2, and the camera 3 have been described above and will not be elaborated on here. The cleaning device 40 is used to clean the viewport of the vehicle sensor 102.

Referring to FIG. 14, which is an internal structural diagram of the main control module provided by an embodiment of the disclosure.

As shown in FIG. 14, the main control module 100 can be a computer device. The main control module 100 includes a memory 901 and a processor 902. The processor 902 is used to run computer program instructions in the memory 901 to implement the cleaning method for a vehicle sensor.

The memory 901 includes at least one type of readable storage medium, which includes a flash memory, a hard disk, a multimedia card, a card-type memory (e.g., an SD or DX memory, etc.), a magnetic memory, a magnetic disk, an optical disc, etc. In some embodiments, the memory 901 can be an internal storage unit of the computer device, such as a hard disk of the computer device. In other embodiments, the memory 901 can also be an external storage device of the computer device, such as a plug-in hard disk configured in the computer device, a Smart Media Card (SMC), a Secure Digital (SD) card, a Flash Card, etc. Furthermore, the memory 901 can include both internal storage units and external storage devices of the computer device. The memory 901 can not only be used to store application software and various data installed in the computer device, such as the code of the cleaning method for a vehicle sensor, but also be used to temporarily store data that has been output or is to be output.

Furthermore, the main control module 100 also includes a bus 903. The bus 903 can be a Peripheral Component Interconnect (PCI) bus, an Extended Industry Standard Architecture (EISA) bus, etc. The bus can be divided into an address bus, a data bus, a control bus, etc. For the sake of convenience of representation, only one thick line is used to represent it in FIG. 14, but it does not indicate that there is only one bus or only one type of bus.

Furthermore, the main control module 100 can also include a display component 904. The display component 904 can be an LED display, a liquid crystal display, a touch-sensitive liquid crystal display, an Organic Light-Emitting Diode (OLED) toucher, etc. The display component 904 can also be appropriately referred to as a display device or display unit for displaying information processed in the main control module 100 and for displaying a visual user interface.

Furthermore, the main control module 100 can also include a communication component 905. The communication component 905 can optionally include wired communication components and/or wireless communication components (such as WI-FI communication components, Bluetooth communication components, etc.), which are usually used to establish communication connections between the main control module 100 and other computer devices.

FIG. 14 only shows the main control module 100 with some components and implementing the cleaning method for a vehicle sensor. Those skilled in the art can understand that the structure shown in FIG. 14 does not constitute a limitation on the main control module 100. It can include fewer or more components than those shown in the figure, or some components can be combined, or different component arrangements can be used.

In the above embodiments, when the vehicle enters a cold start phase, the viewport of the vehicle sensor is scanned to obtain corresponding viewport data, which is combined with predetermined dirt features to determine whether the viewport is dirty. When dirt is present, the cleaning device is controlled to clean the viewport to ensure that the corresponding viewport of the vehicle sensor is in a clean state when the vehicle starts, avoiding inaccurate data of the vehicle sensor due to untimely cleaning of a dirty viewport, thereby improving the safety of the vehicle's intelligent driving.

Obviously, those skilled in the art can make various modifications and variations to the disclosure without departing from the spirit and scope of the disclosure. In this case, if these modifications and variations of the disclosure fall within the scope of the claims of the disclosure and their equivalent technologies, the disclosure also intends to include these modifications and variations.

It should be understood that although the various steps in the flowcharts of the drawings are shown in sequence as indicated by the arrows, these steps are not necessarily performed in sequence as indicated by the arrows. Unless explicitly stated otherwise in this specification, the execution of these steps is not strictly limited in sequence, and they can be performed in other sequences. Moreover, the flowcharts of the drawings include at least one part of the steps that can include multiple sub-the steps or multiple stages. These sub-the steps or stages are not necessarily performed at the same time but can be performed at different times. The execution order is not necessarily performed in sequence but can be performed alternately or alternately with other steps or sub-the steps or stages of other steps.

The above-listed embodiments are merely preferred embodiments of the disclosure and should not be used to limit the scope of the rights of the disclosure. Therefore, equivalent changes made in accordance with the claims of the disclosure still fall within the scope covered by the disclosure.

1. A cleaning method for a vehicle sensor, the vehicle sensor having a viewport, the cleaning method for the vehicle sensor comprising:
controlling the vehicle sensor to scan the viewport to obtain viewport data of the vehicle sensor when the vehicle enters a cold start phase;
determining whether dirt exists on the viewport based on the viewport data and predetermined dirt features; and
controlling a cleaning device to clean the viewport when dirt on the viewport is detected.

2. The cleaning method for the vehicle sensor according to claim 1, wherein determining whether dirt exists on the viewport based on the viewport data and the predetermined dirt features comprises:
reading historical viewport data of the vehicle sensor, wherein the historical viewport data is stored in the vehicle and represents viewport data of the vehicle sensor prior to the vehicle entering the cold start phase;
determining whether the viewport data possesses predetermined dirt features based on the historical viewport data and the viewport data; and
detecting dirt on the viewport when the viewport data possesses predetermined dirt features.

3. The cleaning method for the vehicle sensor according to claim 1, wherein controlling the cleaning device to clean the viewport comprises:
determining dirt region features of the viewport based on the viewport data, wherein the dirt region features include a contaminated region and a dirt type; and
generating a dirt signal based on the dirt region features and transmitting the dirt signal to the cleaning device, such that the cleaning device cleans the viewport in response to the dirt signal.

4. The cleaning method for the vehicle sensor according to claim 3, wherein the cleaning device cleaning the viewport in response to the dirt signal comprises:
determining a cleaning way corresponding to the dirt type based on the dirt type, wherein the cleaning way is one or more of a detergent cleaning way, a water rinsing method, an air rinsing method, a water-air mixing method, or a wiping method; and
controlling the cleaning device to clean the viewport using the corresponding cleaning way.

5. The cleaning method for the vehicle sensor according to claim 1, wherein the vehicle sensor is equipped with an angle sensor. The cleaning method for the vehicle sensor further comprises:
acquiring angular information of the vehicle sensor using the angle sensor, wherein the angular information represents an angle between a current position of the vehicle sensor and a preset position; and
adjusting positions of the vehicle sensor and/or the cleaning device based on the angular information to ensure the cleaning region of the cleaning device at least covers the viewport.

6. The cleaning method for the vehicle sensor according to claim 1, wherein after controlling the cleaning device to clean the viewport, the cleaning method for the vehicle sensor further comprises:
terminating the process when it is determined that no dirt exists on the viewport during any predetermined cleaning cycle within a preset number of cleaning attempts; and
controlling the cleaning device to stop cleaning and generating a reminder message when the preset number of cleaning attempts is reached and dirt is still detected on the viewport, wherein the reminder message notifies a user that dirt remains on the viewport.

7. The cleaning method for the vehicle sensor according to claim 2, wherein the cleaning method for the vehicle sensor further comprises:
controlling the vehicle sensor to scan the viewport to obtain operational viewport data when the vehicle is not in the cold start phase; and
transmitting a cleaning signal to the cleaning device when dirt is detected on the viewport based on the operational viewport data and predetermined dirt features, such that the cleaning device cleans the viewport in response to the cleaning signal.

8. The cleaning method for the vehicle sensor according to claim 3, wherein the vehicle sensor includes a Lidar, a millimeter-wave radar, and a camera, the cleaning region covers viewports of one or more of the Lidar, the millimeter-wave radar, and the camera, the dirt signal includes a first dirt signal, a second dirt signal, and a third dirt signal, which respectively correspond to viewport data of the Lidar, the millimeter-wave radar, and the camera.

9. A cleaning system for a vehicle sensor, the vehicle sensor having a viewport, the cleaning system for the vehicle sensor comprising:
a cleaning device, and
a main control module, including:
a memory, configured to store computer programs; and
a processor, configured to execute the computer programs to perform a cleaning method for the vehicle sensor, the cleaning method for the vehicle sensor comprising:
controlling the vehicle sensor to scan the viewport to obtain viewport data of the vehicle sensor when the vehicle enters a cold start phase;
determining whether dirt exists on the viewport based on the viewport data and predetermined dirt features; and
controlling a cleaning device to clean the viewport when dirt on the viewport is detected.

10. The cleaning system for the vehicle sensor according to claim 9, wherein determining whether dirt exists on the viewport based on the viewport data and the predetermined dirt features comprises:
reading historical viewport data of the vehicle sensor, wherein the historical viewport data is stored in the vehicle and represents viewport data of the vehicle sensor prior to the vehicle entering the cold start phase;
determining whether the viewport data possesses predetermined dirt features based on the historical viewport data and the viewport data; and
detecting dirt on the viewport when the viewport data possesses predetermined dirt features.

11. The cleaning system for the vehicle sensor according to claim 9, wherein controlling the cleaning device to clean the viewport comprises:
determining dirt region features of the viewport based on the viewport data, wherein the dirt region features include a contaminated region and a dirt type; and
generating a dirt signal based on the dirt region features and transmitting the dirt signal to the cleaning device, such that the cleaning device cleans the viewport in response to the dirt signal.

12. The cleaning system for the vehicle sensor according to claim 11, wherein the cleaning device cleaning the viewport in response to the dirt signal comprises:
determining a cleaning way corresponding to the dirt type based on the dirt type, wherein the cleaning way is one or more of a detergent cleaning way, a water rinsing method, an air rinsing method, a water-air mixing method, or a wiping method; and
controlling the cleaning device to clean the viewport using the corresponding cleaning way.

13. The cleaning system for the vehicle sensor according to claim 10, wherein the vehicle sensor is equipped with an angle sensor, the cleaning way for the vehicle sensor further comprises:
acquiring angular information of the vehicle sensor using the angle sensor, wherein the angular information represents an angle between a current position of the vehicle sensor and a preset position; and
adjusting positions of the vehicle sensor and/or the cleaning device based on the angular information to ensure the cleaning region of the cleaning device at least covers the viewport.

14. The cleaning system for the vehicle sensor according to claim 10, wherein after controlling the cleaning device to clean the viewport, the cleaning method for the vehicle sensor further comprises:
terminating the process when it is determined that no dirt exists on the viewport during any predetermined cleaning cycle within a preset number of cleaning attempts; and
controlling the cleaning device to stop cleaning and generating a reminder message when the preset number of cleaning attempts is reached and dirt is still detected on the viewport, wherein the reminder message notifies a user that dirt remains on the viewport.

15. The cleaning system for the vehicle sensor according to claim 11, wherein the cleaning method for the vehicle sensor further comprises:
controlling the vehicle sensor to scan the viewport to obtain operational viewport data when the vehicle is not in the cold start phase; and
transmitting a cleaning signal to the cleaning device when dirt is detected on the viewport based on the operational viewport data and predetermined dirt features, such that the cleaning device cleans the viewport in response to the cleaning signal.

16. The cleaning system for the vehicle sensor according to claim 3, wherein the vehicle sensor includes a Lidar, a millimeter-wave radar, and a camera, the cleaning region covers viewports of one or more of the Lidar, the millimeter-wave radar, and the camera, the dirt signal includes a first dirt signal, a second dirt signal, and a third dirt signal, which respectively correspond to viewport data of the Lidar, the millimeter-wave radar, and the camera.

17. A vehicle, comprising:
a vehicle body;
a vehicle sensor mounted to the vehicle, and having a viewport;
a cleaning device, configured to clean the viewport; and
a main control module comprising:
a memory configured to store computer programs; and
a processor configured to execute the computer programs to perform the cleaning method, the cleaning method comprising:
controlling the vehicle sensor to scan the viewport to obtain viewport data of the vehicle sensor when the vehicle enters a cold start phase;
determining whether dirt exists on the viewport based on the viewport data and predetermined dirt features; and
controlling a cleaning device to clean the viewport when dirt on the viewport is detected.

18. The vehicle according to claim 17, wherein determining whether dirt exists on the viewport based on the viewport data and the predetermined dirt features comprises:
reading historical viewport data of the vehicle sensor, wherein the historical viewport data is stored in the vehicle and represents viewport data of the vehicle sensor prior to the vehicle entering the cold start phase;
determining whether the viewport data possesses predetermined dirt features based on the historical viewport data and the viewport data; and
detecting dirt on the viewport when the viewport data possesses predetermined dirt features.

19. The vehicle according to claim 17, wherein controlling the cleaning device to clean the viewport comprises:
determining dirt region features of the viewport based on the viewport data, wherein the dirt region features include a contaminated region and a dirt type; and
generating a dirt signal based on the dirt region features and transmitting the dirt signal to the cleaning device, such that the cleaning device cleans the viewport in response to the dirt signal.

20. The vehicle according to claim 19, wherein the cleaning device cleaning the viewport in response to the dirt signal comprises:
determining a cleaning way corresponding to the dirt type based on the dirt type, wherein the cleaning way is one or more of a detergent cleaning way, a water rinsing method, an air rinsing method, a water-air mixing method, or a wiping method; and
controlling the cleaning device to clean the viewport using the corresponding cleaning way.
